(19) United States
(12) Patent Application Publication
(10) Pub. No.: US 2025/0335763 A1
(43) Pub. Date: Oct. 30, 2025

(54) METHOD, ELECTRONIC DEVICE, AND COMPUTER PROGRAM PRODUCT FOR DETERMINING FLOW FIELD PARAMETER OF OBJECT

(71) Applicant: Dell Products L.P., Round Rock, TX (US)

(72) Inventors: Qiang Chen, Shanghai (CN); Pedro Fernandez Orellana, Surfers Paradise (AU)

(21) Appl. No.: 18/671,054

(22) Filed: May 22, 2024

(30) Foreign Application Priority Data
Apr. 26, 2024 (CN) 202410516770.5

(51) Int. Cl. G06N 3/08; G06F 1/20; G06F 30/28

(52) U.S. Cl. CPC G06N 3/08; G06F 1/206; G06F 30/28

(57) ABSTRACT

A method in an illustrative embodiment includes: acquiring a heating parameter and a cooling parameter; and determining, based on the heating parameter and the cooling parameter, a flow field parameter at a target location in an object utilizing a trained neural network model, wherein the flow field parameter includes at least one of temperature, pressure, and flow rate at the target location in the object, and the trained neural network model is trained based on computational fluid dynamics (CFD) simulation sample data. By the method according to embodiments of the present disclosure, fluid parameters at the target location in the object can be determined using the trained neural network model, so that a variety of fine-grained information including temperature, flow rate, pressure, and the like can be obtained without additional physical sensors, and the cost of devices can also be saved.

### RELATED APPLICATION

The present application claims priority to Chinese Patent Application No. 202410516770.5, filed Apr. 26, 2024, and entitled “Method, Electronic Device, and Computer Program Product for Determining Flow Field Parameter of Object,” which is incorporated by reference herein in its entirety.

### FIELD

Embodiments of the present disclosure relate to the field of computer processing, and more particularly to a method, an electronic device, and a computer program product for determining a flow field parameter of an object.

### BACKGROUND

Computing devices such as servers and personal computers typically have built-in sensors for measuring operational parameters of the computing devices. Common built-in sensors include temperature sensors for measuring the temperature of the computing devices. Operating conditions of, for example, processors and memories in the computing devices can be determined by the computing devices based on temperature values measured by the temperature sensors, so that the computing devices can be controlled appropriately. Sensors are critical to maintaining proper operation of the computing devices. Based on measured values from the sensors, the computing devices may adjust their load scheduling and/or clock frequency to ensure that the computing devices can run within a reasonable load range as well as within a safe range.

### SUMMARY

Embodiments of the present disclosure provide a method, electronic device, and computer program product for determining a flow field parameter of an object.

According to a first aspect of the present disclosure, a method for determining a flow field parameter of an object is provided. The method includes: acquiring a heating parameter and a cooling parameter; and determining, based on the heating parameter and the cooling parameter, a flow field parameter at a target location in the object by utilizing a trained neural network model, wherein the flow field parameter includes at least one of temperature, pressure, and flow rate at the target location in the object, and the trained neural network model is trained based on computational fluid dynamics (CFD) simulation sample data.

According to a second aspect of the present disclosure, an electronic device is provided. The electronic device includes at least one processor, and a memory coupled to the at least one processor and having instructions stored therein, wherein the instructions, when executed by the at least one processor, cause the electronic device to perform actions. The actions include: acquiring a heating parameter and a cooling parameter; and determining, based on the heating parameter and the cooling parameter, a flow field parameter at a target location in the object by utilizing a trained neural network model, wherein the flow field parameter includes at least one of temperature, pressure, and flow rate at the target location in the object, and the trained neural network model is trained based on CFD simulation sample data.

According to a third aspect of the present disclosure, a computer program product is provided. The computer program product is tangibly stored on a non-transitory computer-readable medium and includes machine-executable instructions, wherein the machine-executable instructions, when executed by a machine, cause the machine to perform actions. The actions include: acquiring a heating parameter and a cooling parameter; and determining, based on the heating parameter and the cooling parameter, a flow field parameter at a target location in the object by utilizing a trained neural network model, wherein the flow field parameter includes at least one of temperature, pressure, and flow rate at the target location in the object, and the trained neural network model is trained based on CFD simulation sample data.

### BRIEF DESCRIPTION OF THE DRAWINGS

By additional description of exemplary embodiments of the present disclosure, provided herein with reference to the accompanying drawings, the above and other objectives, features, and advantages of the present disclosure will become more apparent, wherein identical reference numerals generally represent identical components in the exemplary embodiments of the present disclosure, and in which:

FIG. 1 is a schematic diagram of an example environment in which embodiments of the present disclosure can be implemented;

FIG. 2 is a flowchart of a method for determining a flow field parameter of an object according to embodiments of the present disclosure;

FIG. 3 is a schematic diagram of an example process for determining a flow field parameter according to embodiments of the present disclosure;

FIG. 4 is a flowchart of a method for dynamically calibrating a flow field parameter according to embodiments of the present disclosure;

FIG. 5 is a schematic diagram of an example process for training a neural network model according to embodiments of the present disclosure; and

FIG. 6 is a block diagram of an example device that may be configured to implement embodiments of the present disclosure.

In various accompanying drawings, identical or corresponding reference numerals represent identical or corresponding parts.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or the same objects. Other explicit and implicit definitions may also be included below.

Computing devices usually have built-in sensors for measuring operating parameters of the computing devices. Sensors are critical to maintaining proper operation of the computing devices. Based on measured values from the sensors, the computing devices may adjust their load scheduling and/or clock frequency to ensure that the computing devices can run within a reasonable load range as well as within a safe range.

However, the number of sensors in the existing computing devices is limited, and the types of sensors are also limited, with the most common ones being temperature sensors, which are used for measuring the temperature of the computing devices. The limitation of the number and type of sensors makes it difficult for the computing devices to obtain fine-grained information. For example, the limitation of the type of sensors makes it difficult for the computing devices to obtain information about pressure or flow rate. The absence of fine-grained information also limits the performance improvement of the computing devices. In addition, adding a larger number of sensors or more types of sensors to a computing device not only increases the cost of the computing device, but also increases the size of the computing device.

Therefore, at least to solve the above problems and other potential problems, embodiments of the present disclosure provide a method for determining a flow field parameter of an object. The method includes: acquiring a heating parameter and a cooling parameter; and determining, based on the heating parameter and the cooling parameter, a flow field parameter at a target location in the object by utilizing a trained neural network model, wherein the flow field parameter includes at least one of temperature, pressure, and flow rate at the target location in the object, and the trained neural network model is trained based on computational fluid dynamics (CFD) simulation sample data.

By the method, fluid parameters at the target location in the object can be determined using the trained neural network model, so that a variety of fine-grained information including temperature, flow rate, pressure, and the like can be obtained without additional physical sensors, and the cost of devices can also be saved. In addition, a user can also adjust the type of an output sample parameter in training sample data for training the neural network model based on the type of a parameter to be measured, thereby allowing for a more flexible and convenient way to sense operating parameters of a computing device.

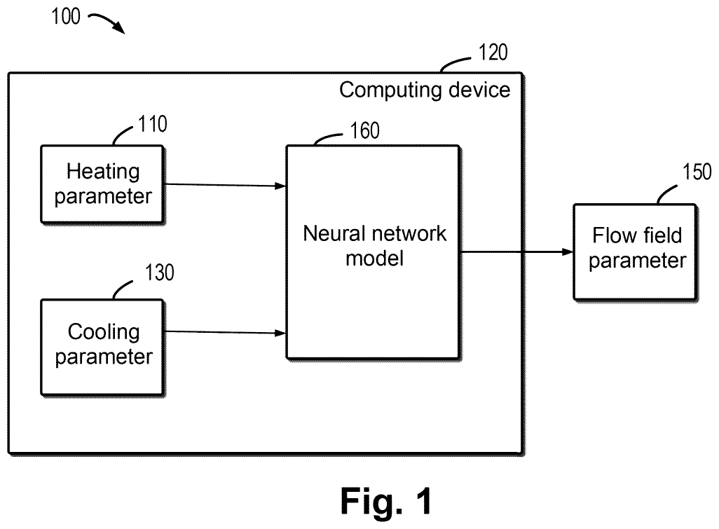

Embodiments of the present disclosure will be further described in detail below with reference to the accompanying drawings. FIG. 1 is a schematic diagram of an example environment 100 in which embodiments of the present disclosure can be implemented.

The example environment 100 includes a computing device 120, and the computing device 120 includes a neural network model 160. In some embodiments, the neural network model 160 may include a deep neural network model. The neural network model 160 may be a trained neural network model. In some embodiments, the computing device 120 may receive CFD simulation sample data and use the received CFD simulation sample data to train a neural network model so as to obtain the trained neural network model 160. In some other embodiments, the neural network model 160 may further include a neural network model trained with the CFD simulation sample data by a computing device different from the computing device 120.

The computing device 120 includes, but is not limited to, a personal computer, a server computer, a handheld or laptop device, a mobile device (such as a mobile phone, a personal digital assistant (PDA), and a media player), a multi-processor system, a consumer electronic product, a wearable electronic device, an intelligent home device, a minicomputer, a mainframe computer, an edge computing device, a distributed computing environment including any of the above systems or devices, etc.

In some embodiments, the computing device 120 may acquire a heating parameter 110 and a cooling parameter 130. The computing device 120 may utilize the trained neural network model 160 to determine a flow field parameter 150 at a target location in an object based on the acquired heating parameter 110 and cooling parameter 130. In some embodiments, the flow field parameter includes at least one of temperature, pressure (e.g., air pressure), and flow rate (e.g., gas flow rate) at the target location in the object, and the trained neural network model 160 may be trained based on the CFD simulation sample data.

By the method for determining a flow field parameter of an object according to embodiments of the present disclosure, fluid parameters at the target location in the object can be determined using the trained neural network model, so that a variety of fine-grained information including temperature, pressure (e.g., air pressure), and flow rate (e.g., gas flow rate) can be obtained without additional physical sensors, and the cost of devices can also be saved. In addition, a user can also adjust the type of an output sample parameter in training sample data for training the neural network model based on the type of a parameter to be measured, thereby allowing for a more flexible and convenient way to sense operating parameters of a computing device.

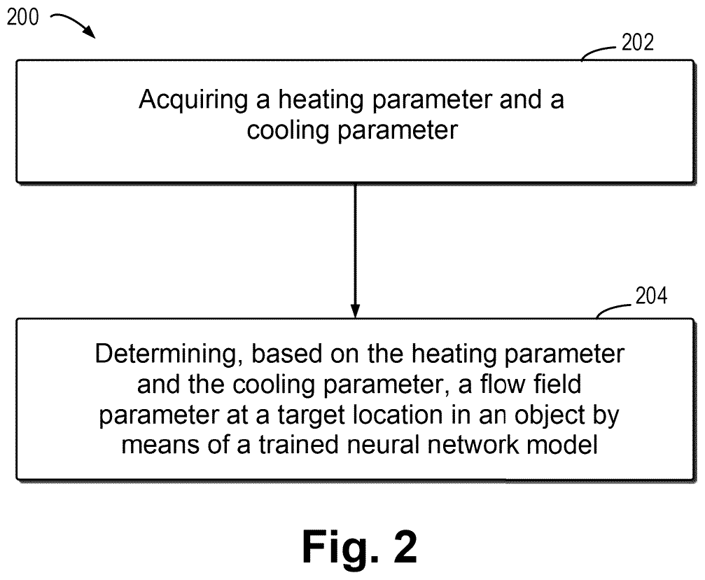

A block diagram of the example environment 100 in which embodiments of the present disclosure can be implemented has been described above with reference to FIG. 1. A flowchart of a method 200 for determining a flow field parameter of an object according to embodiments of the present disclosure will be described below with reference to FIG. 2. The method 200 may be performed at the computing device 120 in FIG. 1 and any suitable computing device.

At block 202, the computing device 120 may acquire a heating parameter and a cooling parameter. In some embodiments, an example is illustrated with an object including the computing device. During running of the computing device 120, components related to heating may include components such as a processor, a storage device, and a power supply apparatus in the computing device. Accordingly, the heating parameter received by the computing device 120 may include one or more of: a first power associated with the processor in the computing device 120; a second power associated with the storage device in the computing device 120; or a third power associated with the power supply apparatus in the computing device 120.

In some embodiments, the computing device 120 may determine the first power by querying a power diagram based on an operating frequency of the processor and a working voltage of the processor. For example, the computing device 120 may acquire the operating frequency of the processor and the working voltage of the processor and feed the acquired operating frequency and working voltage of the processor to the power diagram to query about the power. The computing device 120 may use the obtained power as the first power associated with the processor. In some embodiments, the computing device 120 may obtain the second power associated with the storage device and the third power associated with the power supply apparatus by direct measurement.

In some embodiments, the cooling parameter may include ambient temperature of the environment in which the computing device 120 is located and/or rotational speed of a fan in the computing device.

At block 204, the computing device 120 may determine, based on the heating parameter and the cooling parameter, a flow field parameter at a target location in the object by means of a trained neural network model 160. In some embodiments, the flow field parameter includes at least one of temperature, pressure (e.g., air pressure), and flow rate (e.g., gas flow rate) at the target location in the object, and the trained neural network model 160 may be trained based on the CFD simulation sample data.

In some embodiments, the computing device 120 may further receive location input information (e.g., coordinates) that is used for indicating the target location in the object. The computing device 120 may utilize the trained neural network model to determine the flow field parameter at the target location in the object based on the heating parameter and cooling parameter. In some embodiments, the flow field parameter may include temperature, flow rate (e.g., gas flow rate), and pressure (e.g., air pressure) at the target location. In some embodiments, the flow field parameter may include at least one of temperature, flow rate (e.g., gas flow rate), and pressure (e.g., air pressure) at the target location.

In some embodiments, the neural network model may be trained based on the CFD simulation sample data. In some embodiments, in order to obtain the CFD simulation sample data for training the neural network model, a CFD simulator may be constructed, with a simulation condition (e.g., rotational speed of the fan and power of the computing device) set for the CFD simulator. Under the set simulation condition, the CFD simulator is operated based on an input parameter (e.g., coordinates of a target location in a simulation object), and a simulation result output by the CFD simulator is obtained. Thus, the simulation condition, the input parameter, and the output result constitute a parameter set. The CFD simulator outputs a collection of parameter sets. In some embodiments, sample data for training the neural network model 160 may be selected from the collection of parameter sets. That is, the CFD simulation sample data for training the neural network model may be selected from data obtained by running the CFD simulator. Accordingly, the CFD simulation sample data may include a CFD simulation condition parameter, an input sample parameter, and an output sample parameter at the location with the CFD simulation condition parameter. In some embodiments, the CFD simulation condition parameter represents a condition that is set during running of the CFD simulator, and may correspond to the heating parameter (e.g., the power associated with the computing device) and the cooling parameter (e.g., the ambient temperature and/or the rotational speed of the fan). The input parameter may include coordinates in a grid constructed according to the simulation object; and accordingly, the value of the input parameter may include a value of the coordinates in the grid. The output parameter may include one or more of temperature, flow rate (e.g., gas flow rate), or pressure (e.g., air pressure).

In some embodiments, an output of the CFD simulator may be set based on the type of the flow field parameter to be output by the trained neural network model 160. For example, when the flow field parameter to be output by the trained neural network model 160 includes temperature, flow rate, and pressure, the output of the CFD simulator accordingly includes temperature, flow rate, and pressure. When the flow field parameter to be output by the trained neural network model 160 includes flow rate, the output of the CFD simulator accordingly includes flow rate. The specific training process of the neural network model 160 will be described in detail below in conjunction with the accompanying drawings.

Advantageously, by the method for determining a flow field parameter of an object according to embodiments of the present disclosure, fluid parameters at the target location in the object can be determined using the trained neural network model, so that a variety of fine-grained information including temperature, flow rate, pressure, and the like can be obtained without additional physical sensors, and the cost of devices can also be saved. In addition, a user can also adjust the type of an output sample parameter in training sample data for training the neural network model based on the type of a parameter to be measured, thereby allowing for a more flexible and convenient way to sense operating parameters of a computing device.

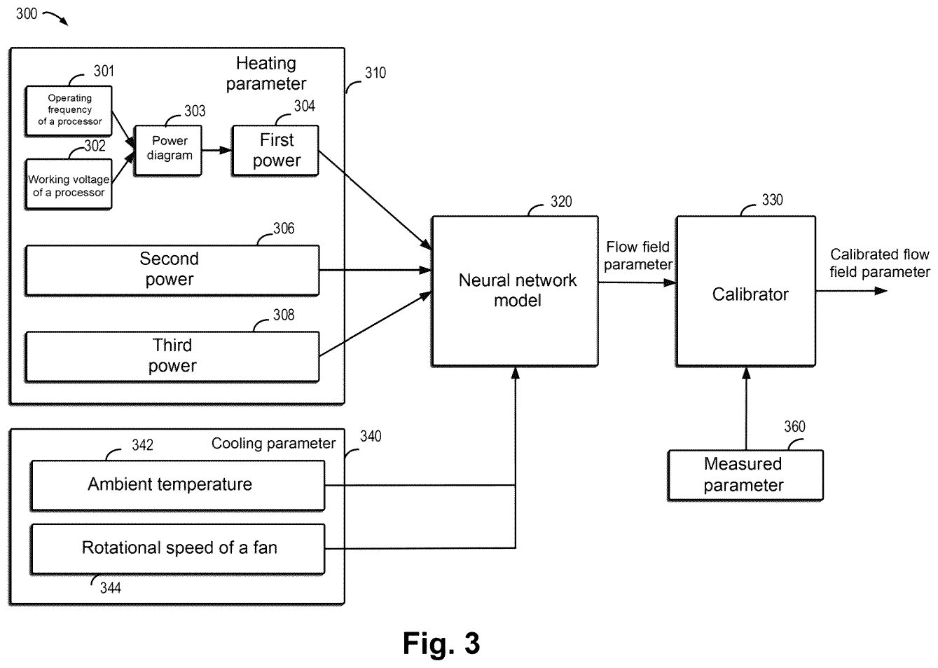

FIG. 3 is a schematic diagram of an example process 300 for determining a flow field parameter according to embodiments of the present disclosure. A neural network model 320 illustrated in FIG. 3 is a trained neural network model (e.g., the neural network model 160) for determining a flow field parameter (e.g., one or more of temperature, flow rate, or pressure) at a target location in an object (e.g., the computing device) according to embodiments of the present disclosure.

In some embodiments, the neural network model 320 may receive a heating parameter 310 and a cooling parameter 340, and may also receive input coordinates for the target location. The neural network model 320 may determine the flow field parameter at the target location based on the heating parameter 310 and the cooling parameter 340.

In some embodiments, the heating parameter 310 may include one or more of a first power 304 associated with the processor of the computing device 120, a second power 306 associated with the storage device in the computing device 120, or a third power 308 associated with the power supply apparatus in the computing device 120, as described above. The first power 304 may be determined by querying a power diagram 303 based on an operating frequency 301 of the processor and a working voltage 302 of the processor. The second power 306 associated with the storage device in the computing device 120 and the third power 308 associated with the power supply apparatus in the computing device 120 may be obtained by measurement. It can be understood that the present disclosure does not impose any limitations on the specific manner of acquiring or determining the first power 304, the second power 306, and the third power 308; and a person skilled in the art may use any suitable technique to obtain one or more of the above powers.

The neural network model 320 may also receive the cooling parameter 340. In some embodiments, the cooling parameter 340 may include ambient temperature 342 and/or rotational speed of a fan 344 in the computing device. In addition, the cooling parameter may also include other parameters.

The neural network model 320 may determine the flow field parameter at the target location of the object (e.g., the computing device 120) based on the heating parameter 310 and the cooling parameter 340. The flow field parameter may include one or more of temperature, flow rate (e.g., gas flow rate), and pressure (e.g., air pressure) at the target location.

As shown in FIG. 3, a calibrator 330 is also illustrated for calibrating the flow field parameter output by the neural network model 320. In some embodiments, the computing device 120 may connect an output of the trained neural network model 320 to the calibrator 330. The computing device 120 may utilize the calibrator 330 to calibrate the flow field parameter determined by the trained neural network model 320. In some embodiments, the calibrator 330 illustratively also receives as an input at least one measured parameter 360.

In some embodiments, the computing device 120 may obtain a preset calibration graph that may correspond to at least one parameter of the flow field parameter. The preset calibration graph may be constructed in an experimental environment. For example, the flow field parameter may be determined in the experimental environment under corresponding construction conditions (e.g., the heating parameter and/or cooling parameter) to construct a corresponding calibration graph. In some embodiments, the calibration graph may be preconstructed based on temperature, flow rate, and pressure, respectively. After the preset calibration graph is acquired, the computing device may calibrate the at least one parameter based on the calibration graph. For example, based on the preset calibration graph on temperature, the computing device 120 may calibrate the temperature parameter output by the neural network model 320.

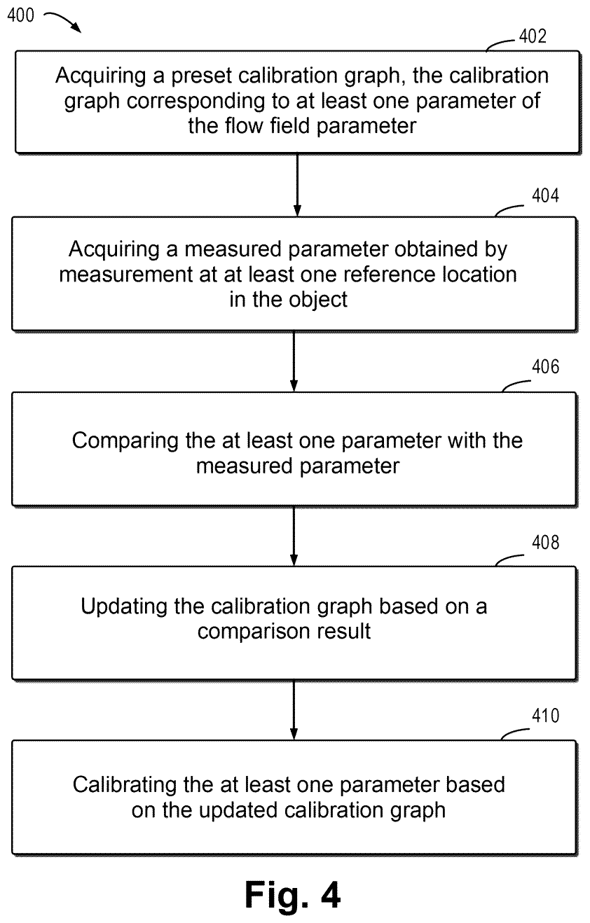

In some embodiments, the computing device 120 may also perform dynamic calibration of the flow field parameter output by the neural network model 320. FIG. 4 is a flowchart of a method 400 for performing dynamic calibration of a flow field parameter according to embodiments of the present disclosure. The method 400 may be performed at the computing device 120 in FIG. 1 and any suitable computing device.

At block 402, the computing device 120 may acquire a preset calibration graph, the calibration graph corresponding to at least one parameter of the flow field parameter. The calibration graph can be understood in conjunction with the previous description above and such description will not be repeated here for the sake of brevity.

At block 404, the computing device 120 may acquire a measured parameter 360 obtained by measurement at at least one reference location in the object. In some embodiments, the at least one reference location may be set in the object, and the measured parameter 360 at the at least one reference location, e.g., one or more of a temperature parameter, a flow rate parameter, or a pressure parameter, may be acquired by means of a physical sensor in real time or at intervals.

At block 406, the computing device 120 may compare the measured parameter 360 with the flow field parameter output by the neural network model 160. In some embodiments, the measurement condition (e.g., including the heating parameter and/or the cooling parameter) corresponding to the process of acquiring the measured parameter 360 is the same as the heating parameter and the cooling parameter when the neural network model 160 outputs the flow field parameter.

At block 408, the computing device 120 may update the calibration graph based on a comparison result. The calibration graph may be updated in any suitable manner, which is not limited by the present disclosure. By updating the calibration graph using parameters measured in real time or at intervals, the calibration graph can be updated over time. Thus, the calibration graph can be dynamically updated during the calibration process by taking into account various factors such as environmental changes and device changes, which can lead to a more accurate calibration result and a more accurate flow field parameter.

At block 410, the computing device 120 may calibrate the at least one flow field parameter output by the neural network model based on the updated calibration graph. For example, based on the updated calibration graph on temperature, the computing device may calibrate the temperature parameter output by the neural network model 320. Based on the updated calibration graph on flow rate, the computing device may calibrate the flow rate parameter output by the neural network model 320. Based on the updated calibration graph on pressure, the computing device may calibrate the pressure parameter output by the neural network model 320.

The training process for the neural network model 160 will be described below in conjunction with the accompanying drawings. In some embodiments, the neural network model 160 is trained based on the CFD simulation sample data. In some embodiments, the CFD simulation sample data includes: a CFD simulation condition parameter; an input sample parameter; and an output sample parameter at the location with the CFD simulation condition parameter.

In some embodiments, a CFD simulator may be constructed in order to obtain training sample data for training the neural network model 160. The CFD simulator may utilize computational resources to perform approximate operation on the fluid motion in a virtual environment so as to obtain corresponding parameters of the fluid motion. In some embodiments, during running of the CFD simulator (e.g., CFD simulation for thermal analysis of the computing device), a simulation condition may be set for the CFD simulator. In some embodiments, the simulation condition may correspond to the heating parameter and cooling parameter received by the neural network model 160 during the process of determining the flow field parameter. In some embodiments, the simulation condition corresponding to the heating parameter may include a power associated with the computing device (e.g., one or more of the first power associated with the processor in the computing device, the second power associated with the storage device in the computing device, or the third power associated with the power supply apparatus in the computing device, as described above). In some embodiments, the simulation condition associated with the cooling parameter may include ambient temperature and/or rotational speed of a fan in the computing device.

In some embodiments, the CFD simulator may receive an input parameter (e.g., a coordinate value at a simulation location in the simulation object) and run based on a simulation condition parameter that has been set, whereby an output parameter at the location with the set simulation condition parameter, e.g., one or more of temperature, flow rate (e.g., gas flow rate), or pressure (e.g., air pressure), may be outputted.

In some embodiments, an output of the CFD simulator may be set based on the type of the flow field parameter to be output by the trained neural network model 160. For example, when the flow field parameter to be output by the trained neural network model 160 includes temperature, flow rate, and pressure, the output of the CFD simulator accordingly includes temperature, flow rate, and pressure. When the flow field parameter to be output by the trained neural network model 160 includes flow rate, the output of the CFD simulator accordingly includes flow rate.

The simulation condition parameter, the input parameter, and the output parameter at the location with the simulation condition parameter may constitute a parameter set. A collection including a plurality of parameter sets can be obtained by running the CFD simulator. In order to train the neural network model, a selection may be made from the collection of the parameter sets obtained above, and the selected parameter sets may be used as CFD simulation sample data. In some embodiments, the CFD simulation sample data may include: a CFD simulation condition parameter, an input sample parameter, and an output sample parameter at the location with the CFD simulation condition parameter.

In some embodiments, the simulation condition may include the heating parameter and/or the cooling parameter. As described above, the power associated with the processor in the computing device may be used to characterize the heating parameter, and the ambient temperature and/or the rotational speed of the fan in the device may be used for characterizing the cooling parameter. Therefore, the simulation condition may be set by setting the power associated with the processor, the ambient temperature, and/or the rotational speed of the fan. In some embodiments, multiple simulation conditions may be set and a CFD simulation may be performed for the object under each simulation condition, such that the output sample parameter corresponding to the input sample parameter may be obtained under each simulation condition.

For example, a first simulation condition may be set, in which the first power, second power, and third power of the processor are P11, P12, and P13, respectively; the ambient temperature is T1, and the rotational speed of a fan is set to r1. Based on the set first simulation condition, a CFD simulation is performed for the simulation object, so that CFD simulation data of the output parameter corresponding to the value of the input parameter under the corresponding first simulation condition can be obtained.

In addition, a second simulation condition may be set, in which the first power, second power, and third power of the processor are P21, P22, and P23, respectively; the ambient temperature is T2, and the rotational speed of the fan is set to r2. Based on the set second simulation condition, a CFD simulation is performed for the simulation object, so that CFD simulation data can be obtained for the output parameter corresponding to the value of the input parameter under the corresponding second simulation condition. Multiple simulation conditions can be similarly set for the simulator, and such additional conditions will not be further described herein for the sake of brevity.

By running the CFD simulator, a collection including a plurality of parameter sets may be obtained. Each of the parameter sets may include a simulation condition parameter, an input parameter, and an output parameter at the location with the simulation condition parameter. In order to train the neural network model, a selection may be made from the collection including the plurality of parameter sets obtained above, and the selected parameter sets may be used as CFD simulation sample data.

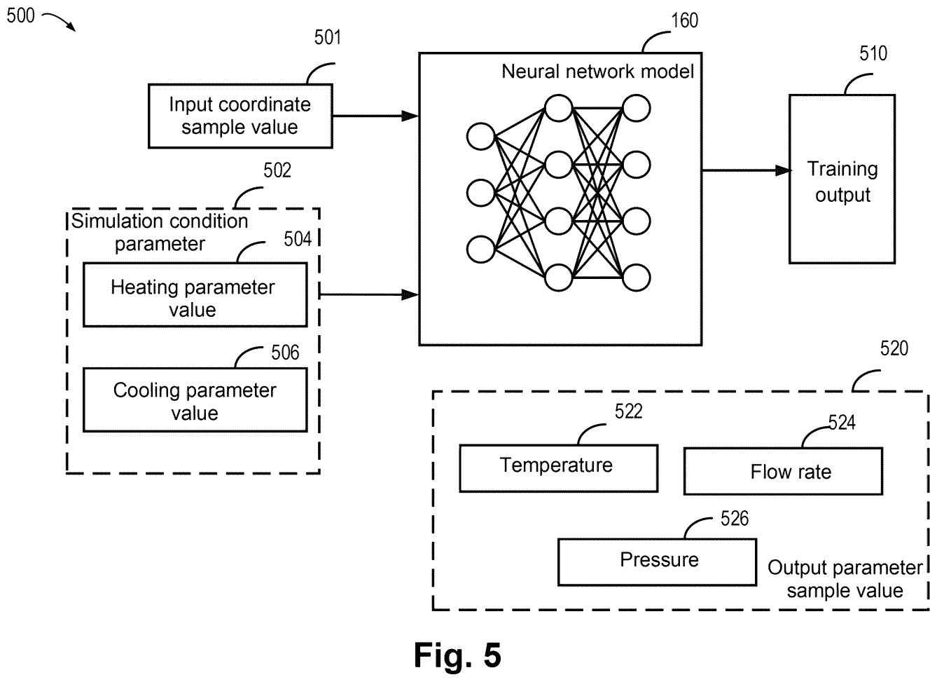

FIG. 5 is a schematic diagram of an example process 500 for training a neural network model 160 according to embodiments of the present disclosure. In order to obtain a neural network model that can determine a flow field parameter of an object, the computing device 120 may train the neural network model 160 with CFD simulation sample data. In some embodiments, the CFD simulation sample data may include: an input sample parameter; a simulation condition parameter; and an output sample parameter at the location with the simulation condition parameter. A simulation condition sample in the CFD simulation sample data may include at least one of a heating parameter value and/or a cooling parameter value. The input parameter may include coordinates in a grid constructed based on the simulation object, and the output parameter sample value may include one or more of temperature, flow rate (e.g., gas flow rate), or pressure (e.g., air pressure).

As shown in FIG. 5, the neural network model 160 may be various types of neural network models, e.g., a deep neural network model. The present disclosure does not impose limitations on the specific structure of the neural network model.

The computing device 120 may acquire training sample data for training the neural network model 160. In some embodiments, the CFD simulation sample data may include: a CFD simulation condition parameter; an input sample parameter; and an output sample parameter at the location with the CFD simulation condition parameter.

As shown in FIG. 5, the CFD simulation sample data for training the neural network model 160 may include: an input coordinate sample value 501, a simulation condition parameter 502, and an output parameter sample value 520. In some embodiments, the simulation condition parameter 502 may include a heating parameter value 504 and a cooling parameter value 506, the heating parameter value 504 may include one or more of the above-described first power, second power, or third power associated with the processor, and the cooling parameter value 506 may include one or more of the ambient temperature or the rotational speed of the fan. In some embodiments, the output parameter sample value 520 includes a sample value of one or more of temperature 522, flow rate 524, and pressure 526.

During training of the neural network model 160, the input coordinate sample value 501 and the simulation condition parameter are input into the neural network model 160. The neural network model 160 outputs a training output 510. The neural network model 160 may be trained in accordance with an appropriately set loss function based on the training output 510 and the output parameter sample value 520 in training data. Any of a wide variety of different techniques can be used to train the neural network model 160, as will be appreciated by those skilled in the art.

In some embodiments, in order to enable the trained neural network model 160 to output more types of flow field parameters, e.g., all types of flow field parameters including temperature, flow rate, and pressure, the output parameter sample value 520 may include temperature 522, flow rate 524 (e.g., gas flow rate), and pressure 526 (e.g., air pressure) in the process of training the neural network model 160. In this way, the neural network model 160 is capable of determining the temperature parameter, the flow rate parameter, and the pressure parameter among the flow field parameters can be obtained. In addition, the neural network model can be trained by overriding more locations in the simulation object with the input parameter (e.g., the input coordinate value), such that the trained neural network model 160 can output the flow field parameter at any location in the object.

In some embodiments, a lightweight neural network model may also be trained to save computational resources and storage occupation. For example, during training of the neural network model 160, at least one of temperature 522, flow rate 524 (e.g., gas flow rate), and pressure 526 (e.g., air pressure) may be included in the output parameter sample value 520. In this way, the neural network model capable of determining at least one of the temperature parameter, the flow rate parameter, and the pressure parameter among the flow field parameters can be obtained. In addition, the neural network model can be trained by overriding one or more specific locations in the simulation object with the input parameter, such that the trained neural network model can output flow field parameters at the one or more specific locations in the object.

Compared with the trained neural network model capable of outputting the temperature, pressure, and flow rate parameters at any location in the object, the trained lightweight model may have fewer neurons and a fewer number of parameters, which can improve the network operation speed, reduce the computational resources, and reduce the storage space occupation.

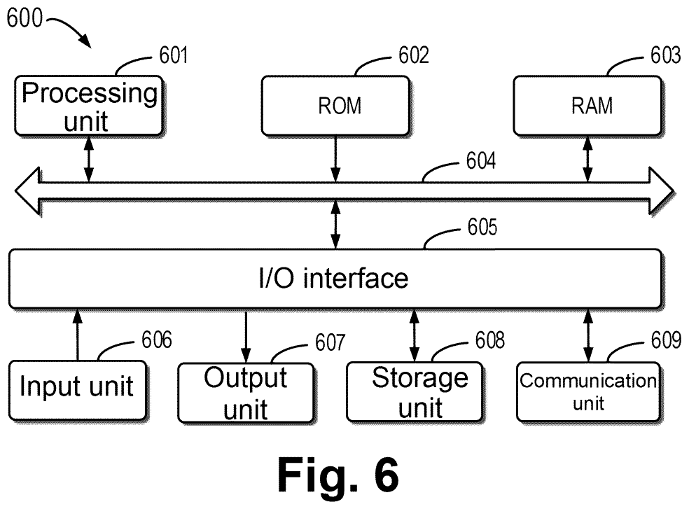

FIG. 6 is a block diagram of an example device 600 that can be used to implement embodiments of the present disclosure. For example, the computing device 120 in FIG. 1 can be implemented by using the device 600. As shown in the figure, the device 600 includes a processing unit (e.g., a central processing unit (CPU)) 601 that may execute various appropriate actions and processing according to computer program instructions stored in a read-only memory (ROM) 602 or computer program instructions loaded from a storage unit 608 to a random access memory (RAM) 603. Various programs and data required for the operation of the device 600 may also be stored in the RAM 603. The processing unit 601, the ROM 602, and the RAM 603 are connected to each other through a bus 604. An input/output (I/O) interface 605 is also connected to the bus 604.

Multiple components in the device 600 are connected to the I/O interface 605, including: an input unit 606, such as a keyboard, a mouse, and the like; an output unit 607, such as various types of displays, speakers, and the like; the storage unit 608, such as a magnetic disk and an optical disc; and a communication unit 609, such as a network card, a modem, a wireless communication transceiver, and the like. The communication unit 609 allows the device 600 to exchange information/data with other devices via a computer network, such as the Internet, and/or various telecommunication networks.

The various processes and processing described above can be executed by processing unit 601. For example, in some embodiments, the method 200 and the method 400 may be implemented as a computer software program that is tangibly included in a machine-readable medium, such as the storage unit 608. In some embodiments, part of or all the computer program can be loaded and/or installed onto the device 600 via the ROM 602 and/or the communication unit 609. When the computer program is loaded to the RAM 603 and executed by the processing unit 601, one or more actions of the method 200 for determining a flow field parameter of an object and the method 400 for calibrating a flow field parameter described above may be executed.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein can be downloaded from a computer-readable storage medium to various computing/processing devices, or downloaded to an external computer or external storage device through a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

Computer program instructions for performing the operations of the present disclosure may be assembly instructions, Instruction Set Architecture (ISA) instructions, machine instructions, machine-related instructions, microcode, firmware instructions, state setting data, or source code or object code written in any combination of one or more programming languages, including object-oriented programming languages such as Smalltalk and C++, and conventional procedural programming languages such as “C” language or the like. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flowcharts and/or block diagrams of the method, apparatus (system), and computer program product according to embodiments of the present disclosure. It should be understood that each block of the flowcharts and/or the block diagrams and combinations of blocks in the flowcharts and/or the block diagrams may be implemented by the computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce means for implementing the functions/acts specified in one or more blocks in the flowcharts and/or block diagrams. These computer-readable program instructions may also be stored in a computer-readable storage medium, and cause a computer, a programmable data processing apparatus, and/or other devices to function in a particular manner, so that the computer-readable medium having the instructions stored thereon includes an article of manufacture including instructions for implementing various aspects of the functions/acts specified in one or more blocks in the flowcharts and/or block diagrams.

The computer-readable program instructions may also be loaded onto a computer, other programmable data processing apparatuses, or other devices, such that a series of operational steps are performed on the computer, other programmable data processing apparatuses, or other devices to produce a computer-implemented process, such that the instructions executed on the computer, other programmable data processing apparatuses, or other devices implement the functions/actions specified in one or more blocks in the flowcharts and/or block diagrams.

The flowcharts and block diagrams in the drawings illustrate the architectures, functions, and operations of possible implementations of the systems, methods, and computer program products according to various embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on the functions involved. It should be further noted that each block in the block diagrams and/or flowcharts as well as a combination of blocks in the block diagrams and/or flowcharts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method for determining a flow field parameter of an object, comprising:
acquiring a heating parameter and a cooling parameter; and
determining, based on the heating parameter and the cooling parameter, a flow field parameter at a target location in the object by utilizing a trained neural network model,
wherein the flow field parameter comprises at least one of temperature, pressure, and flow rate at the target location in the object, and the trained neural network model is trained based on computational fluid dynamics (CFD) simulation sample data.

2. The method according to claim 1, wherein the object comprises a computing device, and the heating parameter comprises at least one of:
a first power associated with a processor in the computing device;
a second power associated with a storage device in the computing device; or
a third power associated with a power supply unit in the computing device.

3. The method according to claim 2, further comprising:
obtaining the first power by querying a power diagram based on an operating frequency of the processor and a working voltage of the processor.

4. The method according to claim 1, wherein the object comprises a computing device, and the cooling parameter comprises at least one of:
ambient temperature; or
rotational speed of a fan in the computing device.

5. The method according to claim 1, further comprising:
connecting an output of the trained neural network model to a calibrator; and
calibrating, by the calibrator, the flow field parameter determined by the trained neural network model.

6. The method according to claim 5, wherein calibrating, by the calibrator, the flow field parameter determined by the trained neural network model comprises:
acquiring a preset calibration graph, the calibration graph corresponding to at least one parameter of the flow field parameter; and
calibrating the at least one parameter based on the calibration graph.

7. The method according to claim 5, wherein calibrating, by the calibrator, the flow field parameter determined by the trained neural network model comprises:
acquiring a preset calibration graph, the calibration graph corresponding to at least one parameter of the flow field parameter;
acquiring a measured parameter obtained by measurement at at least one reference location in the object;
comparing the at least one parameter with the measured parameter;
updating the calibration graph based on a comparison result; and
calibrating the at least one parameter based on the updated calibration graph.

8. The method according to claim 1, wherein the CFD simulation sample data comprises: a CFD simulation condition parameter; an input sample parameter; and an output sample parameter at a location with the CFD simulation condition parameter.

9. The method according to claim 8, wherein the CFD simulation sample data is selected from a plurality of sets of parameters for use in a CFD simulator, and each of the plurality of sets of parameters comprises a simulation condition parameter of the CFD simulator, an input sample parameter, and an output sample parameter at the location with the simulation condition parameter.

10. The method according to claim 1, wherein the trained neural network model is used for determining a flow field parameter at one or more of a plurality of target locations in the object, and the flow field parameter comprises at least one of temperature, pressure, and flow rate.

11. An electronic device, comprising:
at least one processor; and
a memory, coupled to the at least one processor and having instructions stored therein, the instructions when executed by the at least one processor causing the electronic device to perform actions comprising:
acquiring a heating parameter and a cooling parameter; and
determining, based on the heating parameter and the cooling parameter, a flow field parameter at a target location in an object utilizing a trained neural network model,
wherein the flow field parameter comprises at least one of temperature, pressure, and flow rate at the target location in the object, and the trained neural network model is trained based on computational fluid dynamics (CFD) simulation sample data.

12. The electronic device according to claim 11, wherein the object comprises a computing device, and the heating parameter comprises at least one of:
a first power associated with a processor in the computing device;
a second power associated with a storage device in the computing device; or
a third power associated with a power supply unit in the computing device.

13. The electronic device according to claim 12, wherein the instructions, when executed by the at least one processor, cause the electronic device to perform actions:
obtaining the first power by querying a power diagram based on an operating frequency of the processor and a working voltage of the processor.

14. The electronic device according to claim 11, wherein the object comprises a computing device, and the cooling parameter comprises at least one of:
ambient temperature; or
rotational speed of a fan in the computing device.

15. The electronic device according to claim 11, wherein the instructions, when executed by the at least one processor, further cause the electronic device to perform actions:
connecting an output of the trained neural network model to a calibrator; and
calibrating, by the calibrator, the flow field parameter determined by the trained neural network model.

16. The electronic device according to claim 15, wherein calibrating, by the calibrator, the flow field parameter determined by the trained neural network model comprises:
acquiring a preset calibration graph, the calibration graph corresponding to at least one parameter of the flow field parameter; and
calibrating the at least one parameter based on the calibration graph.

17. The electronic device according to claim 15, wherein calibrating, by the calibrator, the flow field parameter determined by the trained neural network model comprises:
acquiring a preset calibration graph, the calibration graph corresponding to at least one parameter of the flow field parameter;
acquiring a measured parameter obtained by measurement at at least one reference location in the object;
comparing the at least one parameter with the measured parameter;
updating the calibration graph based on a comparison result; and
calibrating the at least one parameter based on the updated calibration graph.

18. The electronic device according to claim 11, wherein the CFD simulation sample data comprises: a CFD simulation condition parameter; an input sample parameter; and an output sample parameter at a location with the CFD simulation condition parameter.

19. The electronic device according to claim 11, wherein the trained neural network model is used for determining a flow field parameter at one or more of a plurality of target locations in the object, and the flow field parameter comprises at least one of temperature, pressure, and flow rate.

20. A computer program product, the computer program product being tangibly stored on a non-transitory computer-readable medium and comprising machine-executable instructions, wherein the machine-executable instructions, when executed by a machine, cause the machine to perform actions comprising:
acquiring a heating parameter and a cooling parameter; and
determining, based on the heating parameter and the cooling parameter, a flow field parameter at a target location in an object utilizing a trained neural network model,
wherein the flow field parameter comprises at least one of temperature, pressure, and flow rate at the target location in the object, and the trained neural network model is trained based on computational fluid dynamics (CFD) simulation sample data.
